(19) United States
(12) Patent Application Publication
(10) Pub. No.: US 2012/0312218 A1
(43) Pub. Date: Dec. 13, 2012

(54) Mooring Components

(75) Inventor: Paul McEvoy, Waterford (IE)

(73) Assignee: TECHNOLOGY FROM IDEAS LIMITED, Waterford (IE)

(21) Appl. No.: 13/497,020

(22) PCT Filed: Sep. 20, 2010
(86) PCT No.: PCT/EP10/63823

§ 371 Date: May 29, 2012

(30) Foreign Application Priority Data
Sep. 18, 2009 (EP) 09170681.2

(51) Int. Cl. B63B 21/20; B23P 17/04

(52) U.S. Cl. 114/230.1; 29/407.01

(57) ABSTRACT

A mooring component for use in mooring system comprises a plurality of deformable elements having a reversible non-linear stress-strain response. The deformable elements are formed from elastomeric materials and have different lengths and/or cross-sectional areas and/or are formed from different materials. The overall response of the component is a composite reversible non-linear stress-strain response that is a combination of the responses of each of the plurality of elements. The stress-strain response of the component may be tailored to the expected environmental loading for the location at which the mooring system is to be used.

The present invention relates to mooring components, and in particular, to mooring components suitable for mooring applications where low scope and small footprint are required.

Vessels and other sea-based devices such as fish farms, floating docks, oil rigs and floating wind farms are typically moored to fixed structures such as piers, quays or the seabed using mooring lines or hawsers.

Traditional mooring lines are usually made from synthetic materials, such as nylon or Kevlar. Typically, nylon mooring lines are quite elastic, which allows excess stress to be spread over a number of lines. However, nylon lines can only deliver small elongations of the order of 10%. Mooring lines may also be made from wire rope, which is extremely strong, but difficult to handle and maintain. Lines may also be made from a combination of wire rope and synthetic materials, in which case the line is referred to as a hawser.

However, these mooring solutions that are suitable for deep water or dock mooring are not suitable for low scope or small footprint mooring applications, where some devices, particularly renewable energy devices, need to operate. The “scope” of a mooring is the length of the mooring per unit of water depth. The “footprint” of a mooring is the seabed area occupied by the mooring. The problem lies in the relationship between the size of the waves, drift lengths and/or tidal changes, which are encountered in these environments and the inability of traditional mooring systems to flex with the forces and extension such conditions apply to the mooring, without resorting to large footprints or over-engineered solutions. Each mooring line has a finite breaking point or breaking limit. The higher the breaking limit, the greater the diameter or the higher the grade of material required, and thus the higher the cost of the mooring.

In certain environments, wave heights, drift lengths or tidal changes can easily exceed 25% of the water depth. For example, in non-sheltered ocean locations, wave heights can often exceed 10 metres in water depths of 30 to 40 metres. Tides cause changes in the depth of marine and estuarine water bodies and produce oscillating currents known as tidal streams. Tidal cycles last approximately 12 hours and 25 minutes in most locations and the tidal cycles involve the following sea level changes. Over several hours, water flows in one direction, known as flood flow, reaches a maximum height, known as high tide, and then lowers or falls off as water flows in another (not necessarily opposite) direction known as ebb tide until a low tide level is reached. Mooring systems must be able to cope with the tidal turning. In tidal flow regions, that is, where a moored body is acted on by tidal streams or tidal turning, the drift forces can pull the mooring sizeable distances in one direction (horizontally) and then the other as, the tide changes. In tidal barrage regions, that is, where there is a change in water depth due to tides, the tidal height can change by a few metres in shallow waters. Under any of these conditions, a mooring system needs to be flexible enough to allow for the device to ride the changes without requiring a significant footprint. Failure to achieve this results in significant loads being applied to the mooring system, which must either be designed for (which may result in overengineering of the mooring system) or the system risks breakages. The elasticity of nylon lines is not sufficient for these mooring applications, for example at a seabed depth of 30 metres, in regions where wave heights may be in the region of 10 metres.

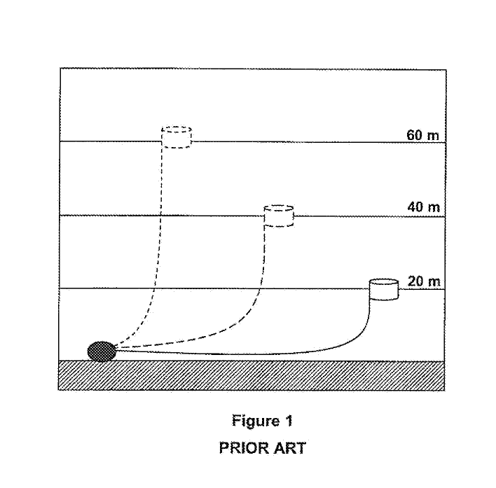

One type of mooring used for certain applications is the catenary mooring. A catenary mooring comprises a free hanging line or cable, running horizontal to the seabed. The restoring force of the mooring line is primarily generated by the hanging weight and pretension in the line. An example of a prior art catenary mooring system is shown in FIG. 1, which illustrates that, as the water depth increases, the weight of chain acting on the floater increases and this can result in large resistive forces being exerted on the floater. Due to the horizontal load reacting nature of the conventional drag embedded anchors which are used with catenary systems, the scope of the cable must therefore be chosen such that the cable is never entirely picked up from the seabed for the given environmental conditions. As shown in FIG. 1, when the water depth is the same order of magnitude as large waves (i.e. depths of 20 m) the length of chain required to deal with changes in water depth of 40-60 m is very large. Normally a scope of three suffices, but in shallower, exposed area scopes of more than five are frequently required. This is often inefficient and takes up a lot of seabed around the device and results in very high costs for the mooring system. Thus a large footprint is required.

Another drawback of this type of system is that, in order to deal with large waves, the chain or cable lifts as the water depth increases and the floater moves both vertically and horizontally to a new position. Thus, a large space envelope is required to allow horizontal movement as water depths rise. This restricts both the density, of floating bodies (e.g. floating platforms) that can be positioned within an area and also the accuracy to which those bodies can be positioned. A further disadvantage of the catenary system is fatigue, as the mooring lines tend to wear at the seabed touch down point.

A catenary mooring system is not ideal for floating tidal or wave energy conversion devices in particular, as the large resistive forces on the mooring line could impede power production. In addition, the disadvantages outlined above can become prohibitive when mooring a device in offshore waters where the waves can be up to 20 m high.

As an alternative to catenary mooring systems based on steel chains, elastomeric mooring solutions are provided by a number of companies, including Supflex®, Seaflex® and Hazelett Marine. The elastic properties of the Hazelett device absorb the peak loads and maintain a lower steady pull on the vessel or device. Under extreme loading, it may elongate up to 300%.

Seaflex® is an elastic mooring system for securing pontoons. The mooring component is a hawser comprising one or more rubber strands and a so-called bypass cable formed of stiff synthetic fibre or wire that prevents the rubber strand(s) from over-extending. The Seaflex® rubber hawser can withstand a force of drag greater than 10 kN and more than 100% elongation to allow the mooring to take care of natural and artificial water level fluctuations.

US 2005/0103251 discloses a flexible mooring rope designed to withstand the tidal currents on a floating platform or pontoon. The rope is made of layers of rubber with synthetic carbon fibres and layers of Kevlar fibres. The rubber content is about 50-60% and the synthetic fibre content is about 40-50%. Multiple such ropes may be connected between end plates to form a hawser.

US 2009/0202306 discloses a mooring cable composed of polyurethane elastomer in an outer layer wrapped around one or more layers of aramid fibre, Kevlar fibre or an ultra-high-molecular-weight polyethylene fibre. The cable also includes a core rope that is braided from a synthetic fibre such as nylon and a polyester rope. Such cables are elastically extendable due to the polyurethane rubber while the core rope provides a fast return force for the cable once the external pull is released.

U.S. Pat. No. 4,597,351 discloses a shock cord that can be installed between a buoy platform and a mooring so as to reduce wave surge loads. The shock cord includes a synthetic rubber core surrounded loosely by an overbraid made of nylon strands. During operation, as the cord begins to stretch, all of the load is carried by the rubber core because the nylon overbraid only loosely covers the core. It is only when the cord is stretched to around three times its relaxed length, for example in severe storm conditions, that the nylon strands go into tension and prevent the rubber core from over-extending. The nylon braiding provides the cord with a high ultimate breaking strength that avoids storm breakage.

U.S. Pat. No. 4,534,262 discloses a marine mooring line comprising an inner core of high stretch material such as nylon. High strength layers of low stretch synthetic fibre such as Kevlar are braided over the inner core. This mooring line is designed to reduce the snapback hazard when the synthetic line breaks.

These, passive elastomeric material solutions are becoming popular in near shore and dock mooring applications. They provide a number of advantages over traditional mooring solutions by allowing a flexible component in the mooring system to stretch with the heave and surge of the vessel or device. They also cause less seabed damage, as additional slackness can be built into the mooring system. However, these mooring systems are principally designed to prevent drift of vessels and are not designed to provide low scope, small footprint performance in deeper waters. These current elastomeric solutions work well where the change in height is small with respect to the depth of water in which the mooring is used, such as in-harbour pontoons, where wave heights are low with respect to water depth, and in estuaries, where tidal changes in water height are low.

The elastic mooring lines described above that comprise rubber elements and a stiff bypass cable to prevent over-extension are limited in the lengths to which they can be made, as the synthetic fibre or steel bypass cable adds disproportionately to the weight of the component. In practice such lines are no more than about 10 m long and therefore find most use in mooring pontoons and boats parked in a marina. The braided synthetic ropes in these hawsers can also suffer from wear problems.

Although the currently available elastic lines such as Seaflex® may be able to withstand severe weather conditions without breaking, they provide, a steeply increasing stress-strain response upon elongation and may therefore apply relatively high forces e.g. >5 kN on the mooring system. While they provide a natural non-linear stress strain response to applied wave forces, they do not deliver the performance and response curves required for more challenging mooring environments. In order to achieve the level of performance required for these applications, a relatively large scope, that is, length per unit of depth and a large seabed footprint are required. This means that more material, or higher-grade material, must be used, thereby increasing cost.

Typically, these elastomeric solutions comprise a multi-strand elastomeric component. The elastomeric strands are all the same e.g. in terms of material, length and diameter. Although a longer strand, e.g. composed of stiff Kevlar or Dyneema fibre, may also be provided to lock the rubber strands from over-extension and to absorb the sudden shock force of a storm wave, this extension-locking strand does not contribute to the normal elastic response of the mooring component. The number of elastomeric strands in the component may be varied in order to vary the damping response achieved. However, the response of the component to applied forces varies only in scale, and the basic response achieved remains the same. Thus, the response may only be tailored to one particular sea state or environmental loading (i.e. a fixed height to depth or current to depth ratio). In deeper or faster waters, the component is likely to snap due to excessive ratio change.

Ideally, a deep sea mooring system needs to be adaptable to the sea states at the location at which it is placed and so it must adjust to the applied forces from the waves over very short time periods. Ideally, the mooring system is self-adjusting so that risk of failure in harsh environments is reduced. Ideally, the mooring system should absorb load forces at the lowest possible breaking limit. It should also be cost-effective.

WO 96/27055 describes a hysteretic damping apparatus and method which uses one or more tension elements fabricated from shape memory alloy to cycle through a superelastic stress-strain hysteresis. The damping apparatus may be designed to have a selected stroke or force capacity by adjusting the length, thickness and number of the tension elements. The tension elements may be in the form of wire loops or bands and can be used to damp movement of structures such as offshore-platforms subject to wave movement.

There are a number of disadvantages associated with this damping apparatus. First of all, this is a pure damping system which is concerned only with dissipation, of energy. In a wave energy environment, this device would very quickly overheat and would be unable to dissipate the energy that deep sea waves contain. This apparatus is also unsuitable for any large scope mooring applications, since a large amount of heat is generated in dissipating such large quantities of energy. Additionally, the shape memory alloy materials used are usually unsuitable for a marine environment.

The present invention seeks to provide improved mooring components and systems that can withstand large changes in wave height while having a low scope and small footprint.

According to a first aspect of the present invention, there is provided a mooring component for a mooring system, comprising:
a plurality of different deformable elements that are elongate flexible elements having a reversible non-linear stress-strain response, wherein each element comprises an elastomeric material and wherein the response is a composite reversible non-linear stress-strain response that is a combination of the responses of each of the plurality of elements.

As the overall response of the mooring component is a composite response arising from the plurality of different elastomeric elements, the stress-strain response, of the component may be tailored to the expected environmental loading for the location at which the mooring system is to be used. This tailoring may be achieved through selection of the different elastomeric elements.

An advantage of the present invention is that, because a composite response is provided, a single mooring component may effectively be tailored to cope with a number of sea states or environmental conditions. More complex stress-strain profiles may be achieved than is possible with a single material or element, or a group of similar or identical elements. The composite stress-strain profile may have a number of points of non-linearity, such that the deformable element provides a sharp increase in counterforce at several thresholds or levels of applied force, with a substantially linear response between those points. This means that the scope and the seabed footprint of the mooring system may be reduced, while providing an improved response to a variety of environmental loads. The tailored non-linear stress strain response allows for a wide range of potential response curves to be designed into the system, with desired forces delivered at specific extensions. The material hysteresis can also be tailored allowing for controlled dampening.

The term “tailored” as used herein indicates that the material or materials used are in a shape, form or configuration that allows the stress-strain response to meet a specific desired performance profile. Thus, the selection of the deformable elements may be designed and modified to meet the desired or required curve. Such tailoring is required for each component to optimise its performance for the expected location in which it will be placed and the environmental forces to which it will be subjected.

Preferably, the deformable elements are passive. The term “passive” as used herein indicates that the stress-strain response of the deformable element or damping member is a function of the material or materials comprised therein or their design, shape or configuration, rather than being a mechanical construct requiring some additional input such as air or hydraulic pressure.

The term “composite” as used herein indicates that the stress-strain response is a combined or cumulative or hybrid reversible non-linear stress-strain response. The mooring component comprises a plurality of different deformable elements and the composite response is a combination of the responses of each of the plurality of different elements. Preferably the deformable element has a complex non-linear stress-strain response within its normal operating range. This allows more complex stress-strain profiles to be achieved than can be provided by a single element or portion.

An element having a non-linear stress-strain response is one in which the counterforce exerted by the element is non-linearly related to the force applied thereto and to the rate of application of such force. In the present invention, movement of a moored body in response to wave or tidal motion exerts a force on the deformable member forming the mooring component. The counterforce exerted on the moored body by the deformable elements is non-linearly related to the applied force and the rate of application of that force. The deformable elements of the present invention exhibit a reversible non-linear stress-strain response. For example, the deformable member may be capable of undergoing a reversible change of shape in response to an applied force. Desirably, the mooring component exhibits a plurality of non-linear stress-strain responses within its operating range.

In many mooring applications, there is a requirement for this counterforce to be non-zero, thereby providing a restoring force to return the moored body to its original location.

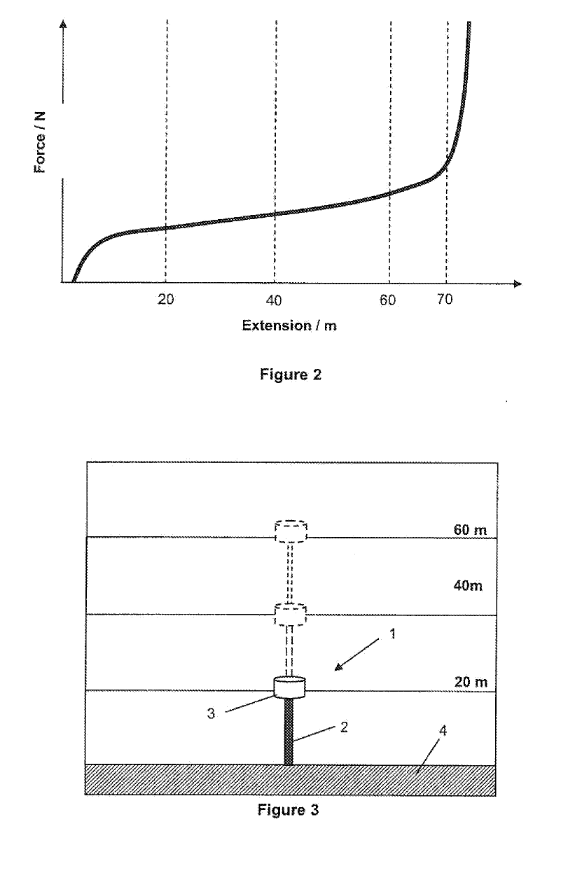

FIG. 2 shows an example of a composite or cumulative non-linear stress-strain response for a mooring component according to the invention. As shown in the figure, a more complex stress-strain profile may be achieved than is possible with a single material or element or with a plurality of elements of the same material, size, etc. As shown, the composite stress-strain profile may have a number of points of non-linearity, such that the component provides a sharp increase in counterforce at several thresholds or levels of applied force, with a substantially linear response between those points.

It can be seen from FIG. 2 that according to this curve the major part of the mooring component response is in a linear region, which can extend between 10-20% and 70-80% of the component's maximum extension. Such a curve is particularly suited to delivering solutions where orbits occur in the movement of the moored device, for example a wave energy conversion device. So long as the extension required by the movement orbit is within the low slope linear region, the force on the device is kept relatively constant and the force on the mooring element is, relatively constant. This has a significant impact on wear lifetimes and peak forces. In at least some preferred embodiments the component therefore delivers a near constant restoring force during normal operation.

In addition, the resistive force applied by the component across the normal operating range may be relatively low, for example ˜3 kN, as compared to ˜5 kN for a conventional catenary mooring based on steel chains. Furthermore the resistivity of the component may stay relatively constant in use. This can be particularly advantageous in a mooring component for a wave or tidal energy conversion device as it means there can be a low or constant resistivity to power take off between floating members. Advantageously the device does not have to cope with large fluctuations in the mooring force.

It can also be seen from FIG. 2 that in extreme conditions, when the component is stretched to beyond 80-90% of its maximum extension, that the restoring force rapidly becomes very large. This ensures that the mooring can survive storms and freak waves. The maximum extension may correspond to an elongation of around 300% for the elastomeric elements in the component.

In some embodiments the composite reversible non-linear stress-strain response may comprise an initial increase in restoring force up to an elongation of 10-20% of the component's initial length. Additionally or alternatively, the response preferably provides a generally constant restoring force in at least a part of the normal operating range of the component, wherein the normal operating range can correspond to an elongation from 20% up to 200%. In at least some embodiments the response may provide a generally constant restoring force for an elongation in the range of one or more of: (i) 20-30%; (ii) 30-40%; (iii) 40-50%; (iv) 50-60%; (v) 60-70%; (vi) 70-80%; (vii) 80-90%; (viii) 90-100%; (ix) 100-110%; (x) 110-120%; (xi) 120-130%; (xii) 130-140%; (xiii) 140-150%; (xiv) 150-160%; (xv) 160-170%; (xvi) 170-180%; (xvii) 180-190%; and (xviii) 190-200%. In preferred embodiments the composite response comprises a sharp increase in restoring force for elongations greater than 100%, 120%, 140%, 160%, 180%, 200%, 220%, 240% or greater than 250%.

It will be understood that FIG. 2 represents one possible ideal response curve that may be particularly suitable, for example, for a wave or tidal energy conversion device. However mooring components and systems in accordance with embodiments of the invention may provide different response curves tailored to various environmental conditions and/or different device needs.

As is explained above, the composite reversible non-linear stress-strain response of the mooring component results from the different elastomeric elements making up the component. The elastomeric elements may be different in a variety of ways.

In one set of preferred embodiments, the mooring component comprises a plurality of elongate flexible elements comprising an elastomeric material wherein at least one element may have a different length to one or more other elements, so that the composite response is a combination of the responses each of the different length elements. The lengths of the different elements are preferably chosen from one of more of the ranges of (i) 5-9 m; (ii) 10-15 m; (iii) 16-20 m; (iv) 21-25 m; (v) 26-30 m; (vi) 31-35 m; (vii) 36-40 m; (viii) 41-45 m; and (ix) 46-50 m. This is the length of the element measured in an unstretched state.

Alternatively, or additionally, at least one element may be formed from a different material to one or more other elements, so that the composite response is a combination of the responses of the material of each of the elements.

In other embodiments, alternatively or additionally, the cross-sectional area (thickness) of at least one element may differ from that of one or more other elements, so that the composite response is a combination of the responses each of the different thickness elements. The thickness of the different elements are preferably chosen from one of more of the ranges of: (i) 0.05-0.1 m; (ii) 0.1-0.2 m; (iii) 0.2-0.3 m; (iv) 0.3-0.4 m; (v) 0.4-0.5 m; (vi) 0.5-0.6 m; (vii) 0.6-0.7 m; (viii) 0.7-0.8 m; (ix) 0.8-0.9 m; and (x) 0.9-1.0 m.

It will be appreciated that the thickness chosen for the elements is very scale dependant. In a mooring component for a full scale wave energy conversion device, for example, forces are likely to be in the range of 1-10 MN during normal operation e.g. ˜3 MN at 100% elongation could be expected. The overall material thickness in the component then depends on the material chosen and the elongation required. Elastomeric elements at ˜100% elongation may typically deliver a tensile strength of 1.2 MPa and so for forces ˜3 MN a total cross-sectional area of 3 MN/1.2 MPa=2.5 m² may be used. This could be shared between six elements each having a diameter of 0.75 m, although in practice the elements are likely to have different thicknesses in order to tailor the overall composite stress-strain response of the component.

Preferably the mooring component comprises at least two, three, four, five, six or more elastomeric elements. By increasing the number of elements the degree to which the composite response can be tailored to a particular application is increased, but at the price of an increased material and manufacturing cost. The plurality of different elastomeric elements may comprise only element that is different to the others. In at least some preferred embodiments the mooring component comprises two, three, four or five elements that are different to the other element(s) in the component. The number of different elements, and the way in which they differ e.g. material, length and/or thickness, can be selected so as to tailor the composite responSe of the component to the sea states in which it is designed to be used.

In one set of embodiments the component preferably comprises three elastomeric elements. The first and/or second elements may have a different length to the third element. Alternatively or additionally, the first and/or second elements may have a different thickness to the third element. Although it is preferred that the three elements all comprise the same elastomeric material, for ease of manufacturing, one, two or all three of the elements may be made of different elastomers.

In another set of embodiments the component preferably comprises four elastomeric elements. The first and/or second and/or third elements may have a different length to the fourth element. Alternatively or additionally, the first and/or second and/or third elements may have a different thickness to the fourth element. Although it is preferred that the four elements all comprise the same elastomeric material, for ease of manufacturing, one, two, three or all four of the elements may be made of different elastomers.

In another set of embodiments the component preferably comprises five elastomeric elements. The first and/or second and/or third and/or fourth elements may have a different length to the fifth element. Alternatively or additionally, the first and/or second and/or third and/or fourth elements may have a different thickness to the fifth element. Although it is preferred that the five elements all comprise the same elastomeric material, for ease of manufacturing, one, two, three, four or all five of the elements may be made of different elastomers.

In another set of embodiments the component preferably comprises six elastomeric elements. The first and/or second and/or third and/or fourth and/or fifth elements may have a different length to the sixth element. Alternatively or additionally, the first and/or second and/or third and/or fourth and/or fifth elements may have a different thickness to the sixth element. Although it is preferred that the six elements all comprise the same elastomeric material, for ease of manufacturing, one, two, three, four, five or all six of the elements may be made of different elastomers.

In at least some embodiments the elastomeric material of the deformable elements comprises a natural rubber or a synthetic rubber such as polyurethane. In at least some other embodiments the elastomeric material of the deformable elements comprises an elastomeric material such as Viton or Neoprene. In one embodiment of the invention, the deformable element may comprise a thermoplastic material (such as Hytrel) in addition to the elastomeric material. These materials are suitable for marine use and may have extreme lifetimes of over 20 years.

The mooring component may comprise one or more non-elastomeric elements in addition to the plurality of different elastomeric elements. In some preferred embodiments, for example, the component may include a stiff line of synthetic rope or metal wire. This line may be provided to prevent over-extension of the elastomeric elements in the event of extreme waves.

Although the component may comprise additional lines to provide tension at least beyond the normal operating range, it is preferable that only the elastomeric elements, or at least some of them, are in tension for an elongation in the range of one or more of: (i) 20-30%; (ii) 30-40%; (iii) 40-50%; (iv) 50-60%; (v) 60-70%; (vi) 70-80%; (vii) 80-90%; (viii) 90-100%; (ix) 100-110%; (x) 110-120%; (xi) 120-130%; (xii) 130-140%; (xiii) 140-150%; (xiv) 150-160%; (xv) 160-170%; (xvi) 170-180%; (xvii) 180-190%; and (xviii) 190-200%. Preferably it is only for elongations greater than 100%, 120%, 140%, 160%, 180%, 200%, 220%, 240% or greater than 250% that any non-elastomeric element is in tension.

It is also envisaged that one or more of the elongate flexible elements may each have its own composite response as a result of a shape or diameter of the elongate flexible element that varies along its length, so that the element comprises a plurality of portions of different shape or diameter and the composite response is a combination of the responses each of the different shape or diameter portions. Alternatively, or additionally, the elongate flexible element may comprise a plurality of portions, wherein a portion comprises a different material to one or more other portions so that the composite response is a combination of the responses of the material of each of the portions.

An elongate flexible element that has its own composite reversible non-linear stress-strain response as described above may be used as a mooring component in its own right without requiring a plurality of different elongate flexible members.

Thus, according to a further aspect of the present invention there is provided a mooring component for a mooring system comprising a deformable element that is an elongate flexible element having a reversible non-linear stress-strain response, wherein the response is a composite reversible non-linear stress-strain response, and wherein:
(i) the shape or diameter or cross-sectional area of the elongate flexible element varies along its length, so that the element comprises a plurality of portions of different shape or diameter or cross-sectional area and the composite response is a combination of the responses each of the different shape or diameter or cross-sectional area portions; and/or
(ii) the elongate flexible element comprises a plurality of portions, wherein a portion comprises a different material to one or more other portions so that the composite response that is a combination of the responses of the material of each of the portions.

An advantage of such mooring components is that the composite response of a single elongate flexible member may be tailored to the expected environmental loading for the location at which the mooring system is to be used. Thus a single elongate flexible element may effectively be tailored to cope with a number of sea states or environmental conditions. More complex stress-strain profiles may be achieved than is possible with a single material or element of constant shape or diameter or cross-sectional area, or with a group of similar or identical elements. In the same way as is described above with respect to the first aspect of the invention, the composite stress-strain profile may have a number of points of non-linearity, such that the deformable element provides a sharp increase in counterforce at several thresholds or levels of applied force, with a substantially linear response between those points. This means that the scope and the seabed footprint of the mooring system may be reduced, while providing an improved response to a variety of environmental loads.

As before, the term “composite” as used herein indicates that the stress-strain response is a combined or cumulative or hybrid reversible non-linear stress-strain response. The mooring component comprises a single deformable element having a plurality of portions and the composite response is a combination of the responses of each of the plurality of different portions. Preferably the deformable element has a complex non-linear stress-strain response within its normal operating range. This allows more complex stress-strain profiles to be achieved than can be provided by a single element or portion.

A mooring component according to this further aspect of the invention may have any of the preferred features described above (in so far as they are not mutually exclusive) in terms of its composite response. In particular, the sample composite response curve shown in FIG. 2 and the corresponding discussion applies equally to embodiments of this aspect of the invention.

In preferred embodiments of this aspect of the invention, the deformable element comprises at least one of a thermoplastic material (such as Hytrel) or an elastomeric material (such as Viton or Neoprene). These materials are suitable for marine use and may have extreme lifetimes of over 20 years.

Some further preferred features relevant to both of the above aspects, of the invention will now be described.

In preferred embodiments, the possible elongation of the component (i.e. the available stretch) is such that a minimum length of component is required to achieve the desired performance. Preferably the component is capable of elongations up to 300%. In at least some embodiments of a mooring system, the component is placed close to the ocean surface (when part of a larger mooring system) to minimise stress on the rest of the mooring system. This ensures that the wave or tidal motion causes only the mooring component (and not the entire mooring system) to stretch. In at least some embodiments of a mooring system, the component is connected between a floating member and a conventional mooring line such as a synthetic rope (e.g. Dyneema) and/or steel chain. The connection may be direct or indirect. One or more of the mooring components may be connected, either in series or in parallel.

In preferred embodiments, the mooring component is relatively short in its unstretched state. For example, a 15 metre long component capable of stretching to 40 metres can reduce the footprint of the mooring system from 150 metres to 40 metres. The elongation of the component will depend on its operating conditions, such as the size of the waves and/or tidal current. As the orbital movement of the moored device may be more restrained as compared to a conventional e.g. catenary mooring system, this can ensure that the stress along the component itself is essentially constant. In at least one set of embodiments the mooring component preferably has a length chosen from: (i) 5-10 m; (ii) 10-15 m; (iii) 15-20 m; (iv) 20-25 m; or (v) 25-30 m. This is the length of the component measured in an unstretched state.

Ideally, the component is submerged (i.e. just below the surface) to reduce heating and to increase the amount of energy that can be dissipated by the deformable element if required.

Preferably the component is connectable, directly or indirectly, between a floating body and the seabed. Suitably, the component is connectable between a floating body, such as a floating fish farm, a floating platform or a floating wind farm, and the seabed. Alternatively, the component is connectable between two (or more) floating bodies. The connection may be direct or indirect. Thus it is preferred in some embodiments that the component is connectable, directly or indirectly, between a first floating body and a second floating body and optionally, the floating bodies form part of an array. In such embodiments the mooring component responds to movement of one floating body by reacting against another floating body that may have greater inertia.

In at least one set of preferred embodiments the component responds differently to different excitation frequencies. Such a response can be achieved through appropriate selection of the different elements or portions of the component.

Such a component may respond to tidal changes, for example, by stretching, but may be unresponsive to changes caused by wave motion.

According to another aspect of the invention, there is provided a mooring system comprising a mooring component as described above. The mooring system may comprise one or more of such components. The mooring system may comprise a combination of mooring component(s) comprising different elements and mooring component(s) comprising different portions. The mooring system may be a mooring system for a deep sea environment, a tidal flow environment or a tidal barrage environment.

In a set of preferred embodiments the mooring system comprises a floating platform and the mooring component is connected between the platform and the seabed. In at least some embodiments the mooring component is preferably connected between the floating platform and a mooring line that is connected to the seabed. The mooring line may comprise a synthetic rope or steel chain. The component may also be connected to the platform by a conventional mooring line, such as a synthetic rope. The floating platform may form part of a tidal or wave energy conversion device.

According to a further aspect of the invention, there is provided a method of manufacturing a mooring component for a deep sea mooring system, comprising the steps of:
identifying a body to be moored and a location in which it is to be moored;
determining the expected environmental loading for the location;
determining the desired stress-strain response of the component to the expected environmental loading; and
providing a plurality of different deformable elements having a reversible non-linear stress-strain response, wherein each element comprises an elastomeric material, and wherein the response is a composite reversible non-linear stress-strain response which is a combination of the responses of each of the plurality of elements and which matches the desired stress-strain response.

According to a yet further aspect of the invention, there is provided a method of manufacturing a mooring component for a deep sea mooring system, comprising the steps of:
identifying a body to be moored and a location in which it is to be moored;
determining the expected environmental loading for the location;
determining the desired stress-strain response of the component to the expected environmental loading; and
providing a deformable element having a plurality of portions and a composite reversible non-linear stress-strain response that is a combination of the responses of each of the plurality of portions and which matches the desired stress-strain response.

Some preferred embodiments of the present invention will now be described, by way of example only, and with reference to the accompanying drawings, in which:

FIG. 1 is a schematic representation of a prior art catenary mooring system;

FIG. 2 is a sample composite response curve of a mooring component according to an embodiment of the present invention;

FIG. 3 is schematic representation of a first embodiment of a mooring system according to the present invention;

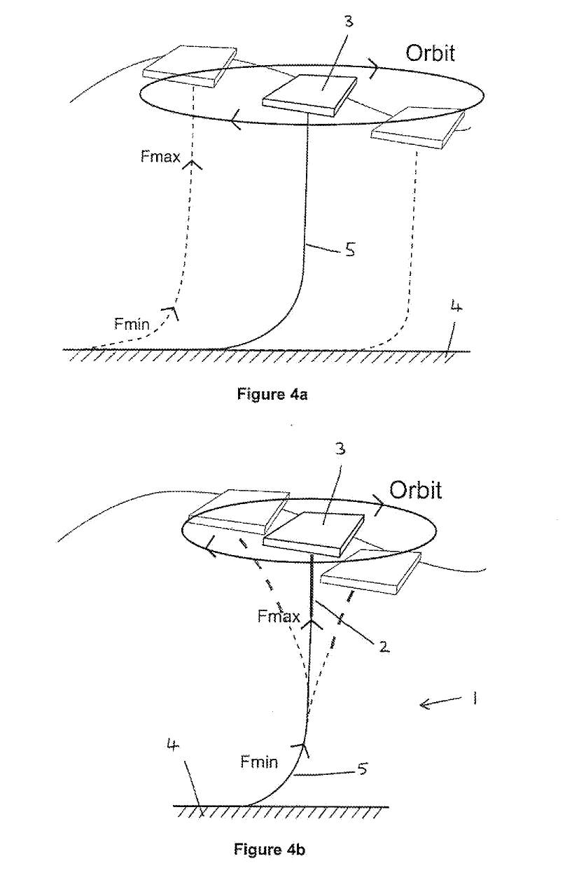

FIG. 4 is a comparison between a prior art mooring system (FIG. 4a) and a mooring system according to an embodiment of the present invention (FIG. 4b);

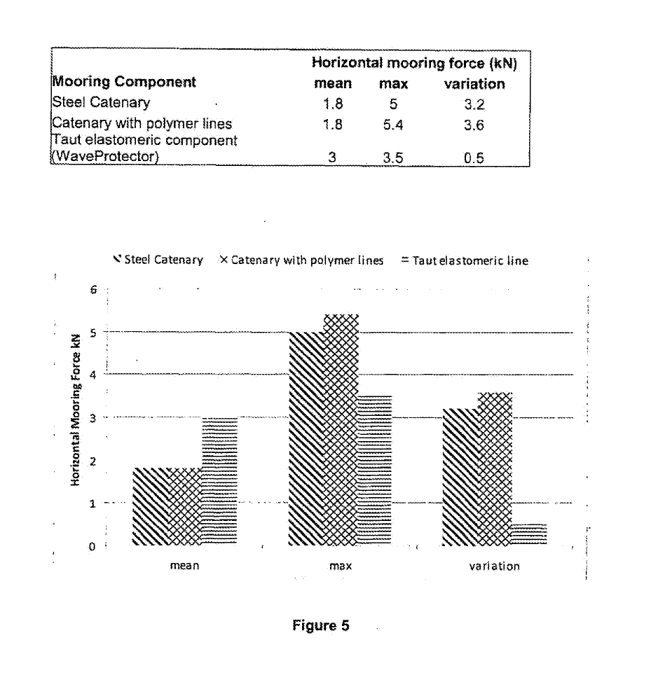

FIG. 5 shows the horizontal mooring forces in a system depending on the type of mooring component;

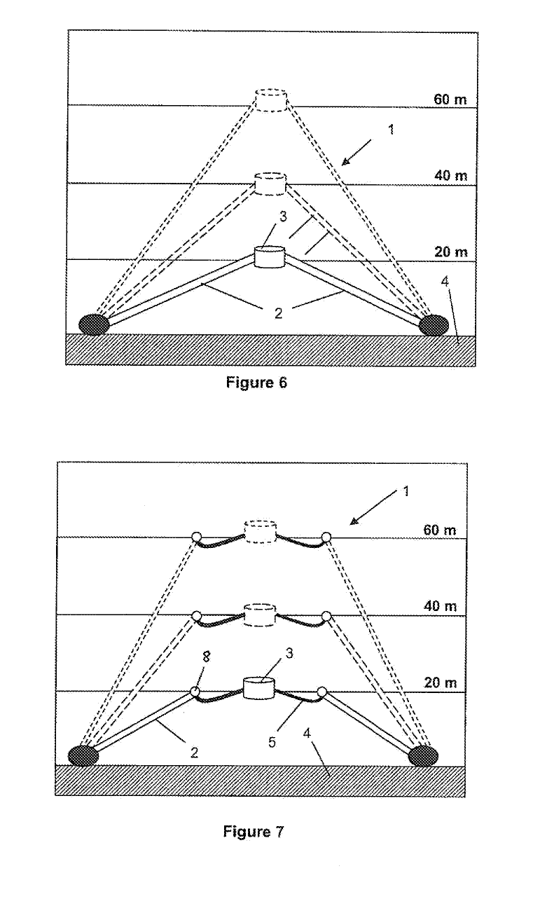

FIG. 6 is schematic representation of a second embodiment of a mooring system according to the present invention;

FIG. 7 is schematic representation of a third embodiment of a mooring system according to the present invention;

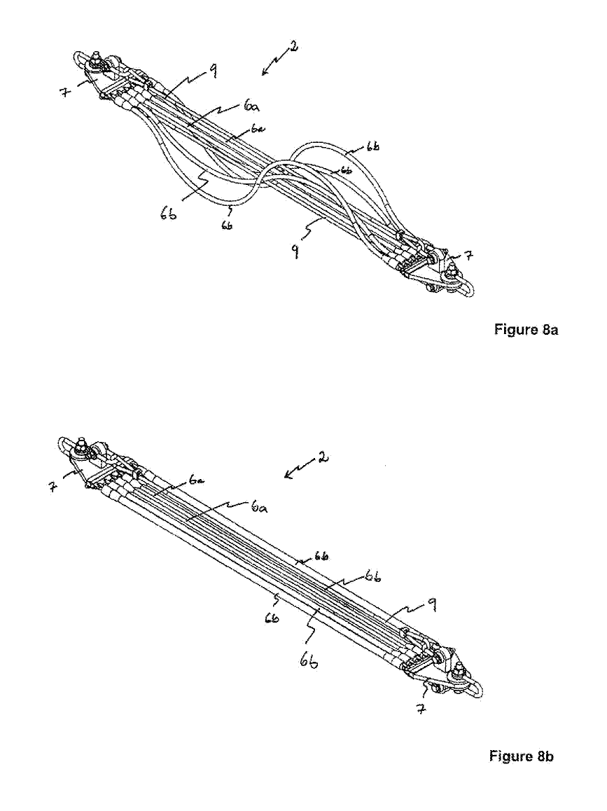

FIG. 8a is a perspective view of a first embodiment of a mooring component according to the present invention, in an unstretched configuration;

FIG. 8b is a perspective view of the mooring component of FIG. 8a, in a stretched configuration;

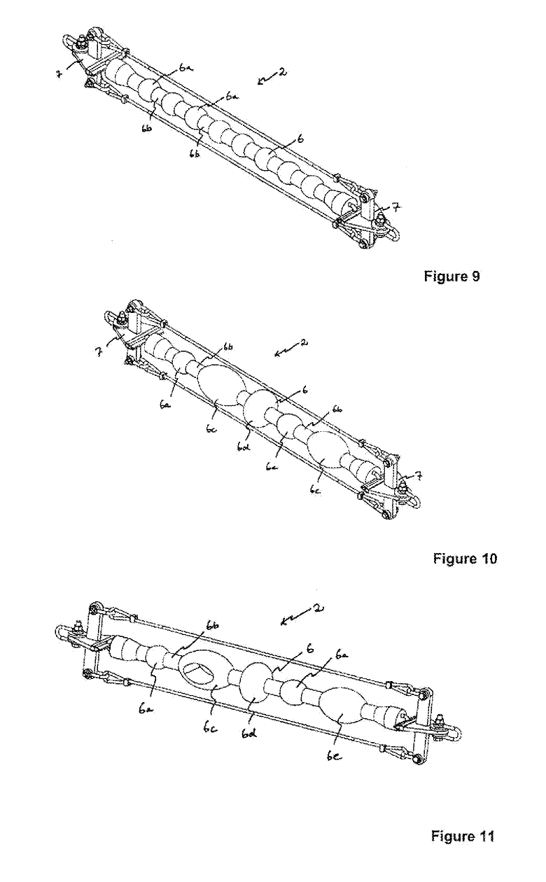

FIG. 9 is a perspective view of a second embodiment of a mooring component according to the present invention;

FIG. 10 is a perspective view of a third embodiment of a mooring component according to the present invention;

FIG. 11 is a perspective view of a fourth embodiment of a mooring component according to the present invention;

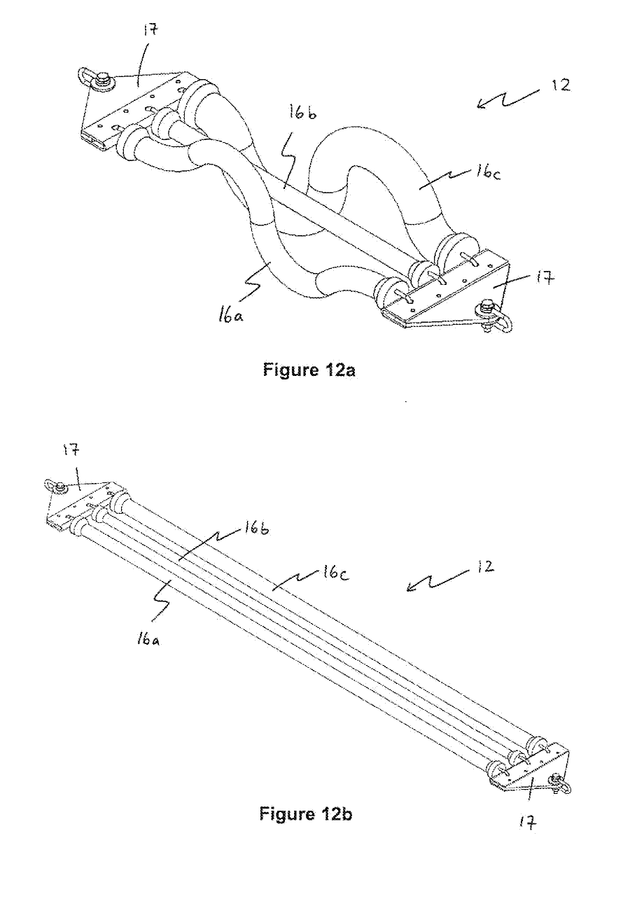

FIG. 12a is a perspective view of a fifth embodiment of a mooring component according to the present invention, in an unstretched configuration;

FIG. 12b is a perspective view of the mooring component of FIG. 12a, in a stretched configuration;

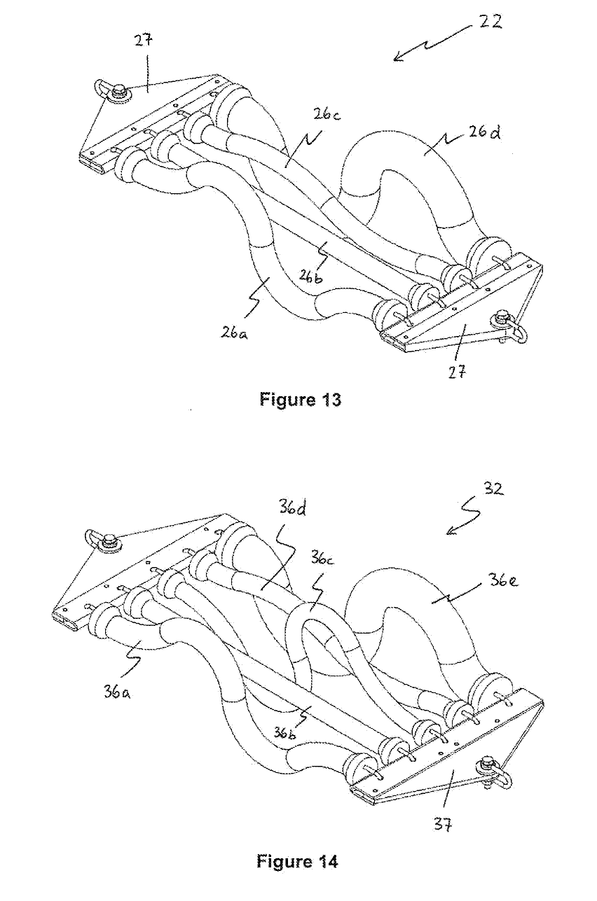

FIG. 13 is a perspective view of a sixth embodiment of a mooring component according to the present invention;

FIG. 14 is a perspective view of a seventh embodiment of a mooring component according to the present invention;

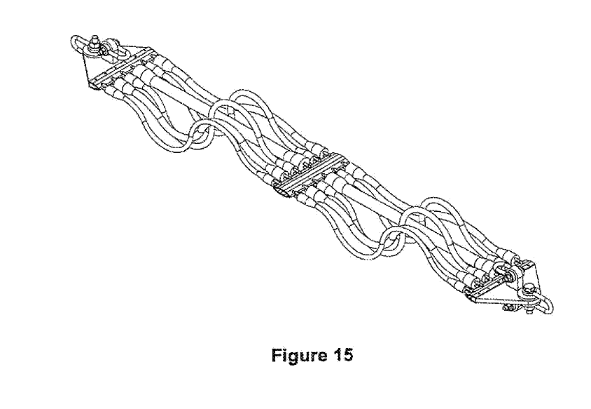

FIG. 15 is a perspective view of an eighth embodiment of a mooring component according to the present invention;

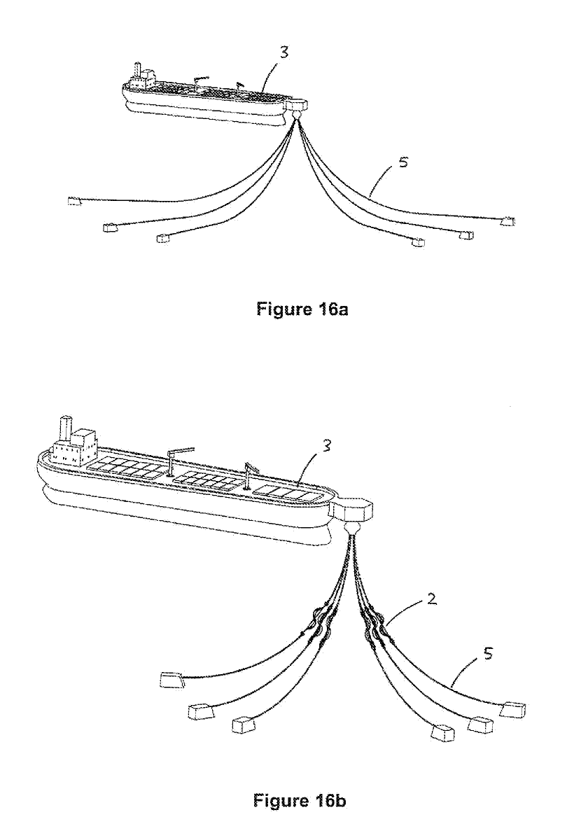

FIG. 16a is a schematic view of a conventional mooring system for a ship;

FIG. 16b is a schematic view of a mooring system for a ship according to an embodiment of the present invention; and

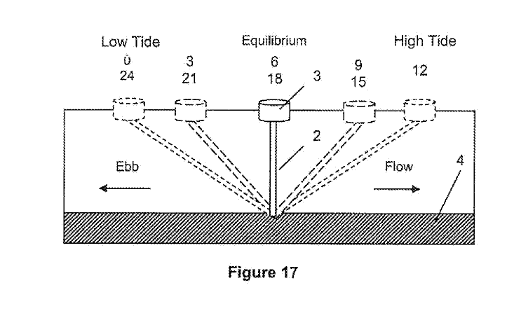

FIG. 17 is schematic representation of an embodiment of a mooring system according to the present invention, adapted for a tidal environment.

FIG. 3 shows an embodiment of a mooring system 1 according to the present invention. The system comprises a mooring component 2 comprising a plurality of different elongate flexible elements that combine to give the mooring component 2 a composite reversible non-linear stress-strain response.

The embodiment shown in FIG. 3 is a taut mooring, in which the mooring component 2 is connected directly between a floating body 3 and the seabed 4. As shown in the drawing, the scope and footprint of the mooring system are minimised.

FIG. 4 provides a comparison between a conventional catenary mooring system (FIG. 4a) and a taut mooring system (FIG. 4b) with an elastomeric component such as is described with respect to FIG. 3 when applied to a floating platform in open water. It can be seen from FIG. 4a that the circular motion of the platform 3 caused by the waves results in a large horizontal motion envelope for the mooring line 5, e.g. a chain, as it is picked up from the ocean floor 4. As the water depth increases due to large waves the catenary chain is lifted off the seabed and the platform moves upwards and to the left. For small waves, the chain is laid along the seabed as the water depth decreases and the platform drifts downwards and to the right. Thus very large amounts of chain and a large space envelope is required to allow horizontal movement as water depths rise and fall. The large footprint of the mooring system restricts the positioning of the platform 3 in an array.

In FIG. 4b, on the other hand, it can be seen that the taut configuration of a mooring component 2 according to the present invention is able to achieve a low scope with a relatively small horizontal motion envelope and small seabed footprint. This results from the high extensibility of the mooring component 2 as compared to a catenary system e.g. using steel chains. The taut configuration of the mooring component 2 significantly reduces the amount of material required, so the orbit of the platform 3 is smaller as the wave heights vary. This allows for greater packing density of floating platforms in an array, for example an array of renewable energy devices such as tidal turbines or wave energy conversion devices.

Furthermore, in FIG. 4b the mooring component 2 is incorporated as a tether connected between the platform 3 and the chain 5 in the lower section of the mooring system 1. The elastomeric component 2 delivers a tailored counter force on the platform 3 and chain 5 as the separation between them increases, significantly reducing the load forces exerted on the lower chain 5. The elastomeric component 2 may be connected to any conventional mooring line 5, such as a steel chain or Dyneema line.

It can be seen from FIG. 4 that the orbital movement of a floating platform 3 may be greatly reduced by using a taut mooring component 2 according to embodiments of the invention. Accordingly the force on the mooring component is reduced. Typically, the total cross sectional area of the mooring line may be reduced by more than 30% when compared with traditional mooring lines, thereby significantly reducing costs.

FIG. 5 provides a comparison between a catenary system with steel lines (A), a catenary system with polymer lines (B) and a taut mooring system (C) such as that shown in the embodiment of FIG. 3. In an extreme load case such as a 100 year storm the total maximum horizontal mooring force may be ˜5 kN, with a variation in loading of ˜3.2 kN. It can be seen that the maximum forces in systems A and B are much larger than in system C. Moreover it can be seen that the variation in the forces on the mooring system is very large for systems A and B, but that in system C the forces vary across a limited range of only 0.5 kN. Thus mooring system C is able to cope much more efficiently with changes in wave height than conventional systems, as a result of the mooring component's nearly constant stress-strain response and low force across a large range of elongation e.g. 20-70%.

As compared to a catenary system, mooring components according to embodiments of the invention can significantly reduce the mooring forces on the system, for example by >75%.

Alternative embodiments of mooring systems 1 according to the present invention are shown in FIGS. 6 and 7. In FIG. 6, the mooring system 1 comprises a pair of mooring components 2, each of which is connected to a floating body 3 and to the seabed 4. In FIG. 7, the mooring system 1 comprises a pair of mooring components 2 which are directly connected to the seabed 4 and which are connected to a floating body 3 by means of a surface or sub-surface buoy 8 and a loose intermediate line 5. The choice of mooring system 1 often depends on the type of loading required for a particular floating body.

As is shown in FIGS. 8a and 8b, in one embodiment, the mooring component 2 of the present invention is provided in the form of a hawser. FIG. 8a shows the mooring component 2 in an unstretched configuration. The component 2 comprises a plurality of elongate flexible elements 6. The six elements 6 are formed from elastomeric materials and have a variety of lengths, as shown in FIG. 8a. Steel connectors 7 are provided at either end of the component 2, so that the component 2 is connectable between a floating body and the seabed. As shown above, the mooring system 1 may also comprise additional components, so that the connections to the floating body and the seabed may be indirect.

In the embodiment shown, several (two of the six) elements 6a are relatively short, whereas the other (four of the six) elements 6b are longer. Each of the elements 6 provides an individual stress-strain response, so that the mooring component 2 has a composite stress-strain response, wherein the composite response a combination of the responses of each of the plurality of different elements 6a, 6b. The longer elements 6b only begin to stretch at longer extensions. The longer elements 6b can have high hysteresis and therefore be used to absorb energy at extreme loads. FIG. 8b shows the component 2 in a stretched state.

It is also seen in FIGS. 8a and 8b that the component 2 may comprise one or more non-elastomeric elements 9 in addition to the plurality of different elastomeric elements 6a, 6b. In the embodiment shown there are two elongate elements 9, one above the plane of the component 2 and one below, that extend between the end connectors 7. The additional lines 9 are formed of steel or stiff polymer fibres (e.g. Dyneema) and act as bypass shock absorbers. Although the lines 9 may be elastic, in normal operation they do not elongate to a large degree e.g. only 30%. The purpose of the bypass lines 9 is to prevent breakage of the component 2 due to a shock force; they do not contribute to the normal composite response curve. The bypass lines 9 may be omitted in other embodiments.

FIG. 9 shows another embodiment of a mooring component 2 according to an aspect of the present invention. In this embodiment, the diameter of the elongate flexible element 6 varies along its length, so that the element comprises a plurality of portions 6a, 6b of different diameter and the composite response is a combination of the responses each of the different diameter portions 6a, 6b.

FIG. 10 shows a further embodiment of a mooring component 2 according to an aspect of the present invention. In this embodiment, the shape of the elongate flexible element 6 varies along its length, so that the element comprises a plurality of portions 6a, 6b, 6c, 6d of different shape and the composite response is a combination of the responses each of the different portions 6a, 6b, 6c, 6d.

FIG. 11 shows yet another embodiment of a mooring component 2 according to an aspect of the present invention. In this embodiment, the shape of the elongate flexible element 6 varies along its length, so that the element comprises a plurality of portions 6a, 6b, 6c, 6d, 6e of different shape. In this embodiment, the shape of portion 6c is more complex in that it is partially hollowed out. The composite response is a combination of the responses each of the different portions 6a, 6b, 6c, 6d, 6e.

FIG. 12 shows an embodiment of a mooring component 12 that consists of three elastomeric elements 16a, 16b, 16c each of different lengths and diameters. A connector 17 is provided at either end of the component 12. It can be seen from FIG. 12a that one element 16b is shorter than the other two elements 16a, 16c. As the component 12 is stretched, the shortest element 16b stretches first and then the two other elements 16a, 16c start to stretch at longer elongations. Thus different ones of the elements contribute to the composite response at different points, and with varying degrees of contribution. The longest element 16c is also the thickest, so as the elongation of the component 12 increases the response is tailored to provide a larger forte. FIG. 12b shows the component 12 in a stretched state. In this embodiment there is no bypass line.

FIG. 13 shows an embodiment of a mooring component 22 that consists of four elastomeric elements 26a-26d each of different lengths and diameters. FIG. 14 shows an embodiment of a mooring component 32 that consists of five elastomeric elements 36a-36e each of different lengths and diameters. As is described above, in these embodiments the different lengths and thicknesses of the elements have been selected so as to tailor the composite response curve for the component. Connectors 27, 37 are provided at the ends of the components 22, 32.

FIG. 15 shows two mooring component sub-sections 42 that each consist of six elastomeric elements 46a-46f of varying lengths and diameters. The two sub-sections 42 are connected together to form a mooring component 40 that may be easier to transport, handle and install as a result of the shorter lengths of the sub-sections 42. A metal connector 48 is shown between the sub-sections 42, however any suitable connection could be used, including synthetic mooring ropes or steel chains if desired. The ends of the component 40 are provided with connectors 47 so that the component 40 can be linked between mooring lines and a floating platform, e.g. in one of the systems described above. Although the two sub-sections 42 are shown as being components that are the same, they could be different in terms of the number of elements and their size, thickness and/or material. Either of the sub-sections 42 could comprise three, four, five or more than six elements instead.

FIG. 16a depicts a conventional catenary mooring system for a ship 3 in which several synthetic mooring lines or steel chains 5 are anchored to the seabed. It can be seen that the lines or chains must be long, e.g. up to 2 km, in order to cope with changes in water depth and to provide the required load along the surface of the seabed. The length of the chain 5 must provide sufficient weight to resist horizontal forces when the heavy ship moves, even on relatively small e.g. 5 m waves. In FIG. 16b there is shown a mooring system comprising components 2 according to the present invention connected between the ship 3 and anchored mooring lines 5. In this system the lines 5 in the mooring system can be much shorter because the components 2 allow for a large degree of elongation and provide a composite stress-strain response in which the load is reduced. The elastomeric components 2 may even reduce the vertical forces in the mooring system to a level that means anchors can be connected directly to the ocean floor instead of laying chains along the seabed.

FIG. 17 is a schematic representation of the movement of a floating body 3 in a tidal flow. The figure shows that, as the tide flows, the floating body 3 drifts in one direction from equilibrium to a maximum offset point at high tide. Then, as the tide ebbs, the floating body 3 starts to drift back in the opposite direction, past equilibrium to reach a maximum offset at low tide. For example, for a water depth of 5 metres, the floating body may drift to an offset position that is ±6 metres from equilibrium. The mooring component 2 connected between the body 3 and the seabed 4 is capable of controlling the floating body 3 over this horizontal range.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

Although the present invention has been described with reference to preferred embodiments, it will be understood by those skilled in the art that various changes in form and detail may be made without departing from the scope of the invention as set forth in the accompanying claims.

1. A mooring component for a mooring system, comprising:
a plurality of different deformable elements that are elongate flexible elements having a reversible non-linear stress-strain response, wherein each element comprises an elastomeric material and wherein the response is a composite reversible non-linear stress-strain response that is a combination of the responses of each of the plurality of elements.

2. A mooring component as claimed in claim 1, wherein the deformable elements are passive.

3. A mooring component as claimed in claim 1, wherein an element of said plurality of elements has a different length to one or more other elements of said plurality of elements, so that the composite response is a combination of the responses each of the different length elements.

4. A mooring component as claimed in claim 3, wherein the different elements each have an unstretched length chosen from one of more of: (i) 5-9 m; (ii) 10-15 m; (iii) 16-20 m; (iv) 21-25 m; (v) 26-30 m; (vi) 31-35 m; (vii) 36-40 m; (viii) 41-45 m; and (ix) 46-50 m.

5. A mooring component as claimed in claim 1, wherein an element of said plurality of elements may be formed from a different material to one or more other elements of said plurality of elements, so that the composite response is a combination of the responses of the material of each of the elements.

6. A mooring component as claimed in claim 1, wherein the cross-sectional area of an element differs from that of one or more other elements, so that the composite response is a combination of the responses each of the different cross-sectional area elements.

7. A mooring component as claimed in claim 6, wherein the different elements each have a thickness chosen from one of more of: (i) 0.05-0.1 m; (ii) 0.1-0.2 m; (iii) 0.2-0.3 m; (iv) 0.3-0.4 m; (v) 0.4-0.5 m; (vi) 0.5-0.6 m; (vii) 0.6-0.7 m; (viii) 0.7-0.8 m; (ix) 0.8-0.9 m; and (x) 0.9-1.0 m.

8. A mooring component as claimed in claim 1, wherein the composite response provides a generally constant restoring force for an elongation in the range of one or more of: (i) 20-30%; (ii) 30-40%; (iii) 40-50%; (iv) 50-60%; (v) 60-70%; (vi) 70-80%; (vii) 80-90%; (viii) 90-100%; (ix) 100-110%; (x) 110-120%; (xi) 120-130%; (xii) 130-140%; (xiii) 140-150%; (xiv) 150-160%; (xv) 160-170%; (xvi) 170-180%; (xvii) 180-190%; and (xviii) 190-200%.

9. A mooring component as claimed in claim 1, wherein the mooring component comprises at least two, three, four, five, six or more elastomeric elements.

10. A mooring component as claimed in claim 1, wherein the component comprises at least first, second and third elastomeric elements and wherein:
(a) at least the first or the second elastomeric elements have a different length to the third elastomeric element; or further elastomeric elements; or
(b) at least the first or the second elastomeric elements have a different thickness to the third elastomeric element or further elastomeric elements.

11-13. (canceled)

14. A mooring component as claimed claim 1, wherein the component comprises one or more non-elastomeric elements in addition to the plurality of different elastomeric elements.

15. A mooring component as claimed in claim 14, wherein only the elastomeric elements, or at least some of them, are in tension for an elongation in the range of one or more of: (i) 20-30%; (ii) 30-40%; (iii) 40-50%; (iv) 50-60%; (v) 60-70%; (vi) 70-80%; (vii) 80-90%; (viii) 90-100%; (ix) 100-110%; (x) 110-120%; (xi) 120-130%; (xii) 130-140%; (xiii) 140-150%; (xiv) 150-160%; (xv) 160=170%; (xvi) 170-180%; (xvii) 180-190%; and (xviii) 190-200%.

16. A mooring component as claimed in claim 14, wherein the non-elastomeric element(s) is/are in tension only for elongations greater than 100%, 120%, 140%, 160%, 180%, 200%, 220%, 240% or greater than 250%.

17. A mooring component as claimed in claim 1, wherein the shape or diameter or cross-sectional area of at least one of the elongate flexible elements varies along its length, so that the element comprises a plurality of portions of different shape or diameter or cross-sectional area so as to result in a composite response that is a combination of the responses each of the different shape or diameter or cross-sectional area portions.

18. A mooring component as claimed in claim 1, wherein at least one of the elongate flexible elements comprises a plurality of portions, wherein a portion comprises a different material to one or more other portions so as to result in a composite response that is a combination of the responses of the material of each of the portions.

19. A mooring component for a mooring system comprising a deformable element that is an elongate flexible element having a reversible non-linear stress-strain response, wherein the response is a composite reversible non-linear stress-strain response, and wherein:
(i) the shape or diameter or cross-sectional area of the elongate flexible element varies along its length, so that the element comprises a plurality of portions of different shape or diameter or cross-sectional area and the composite response is a combination of the responses each of the different shape or diameter or cross-sectional area portions; and/or
(ii) the elongate flexible element comprises a plurality of portions, wherein a portion comprises a different material to one or more other portions so that the composite response that is a combination of the responses of the material of each of the portions.

20. A mooring component as claimed in claim 19, wherein the deformable element comprises at least one of a thermoplastic material or an elastomeric material.

21. A mooring component as claimed in claim 1, wherein the component has an unstretched length selected from the group of: (i) 5-10 m (ii) 10-15 m; (iii) 15-20 m; (iv) 20-25 m; or (v) 25-30 m.

22-23. (canceled)

24. A mooring component as claimed in claim 1, further comprising, in combination, a mooring system for a tidal or wave energy conversion device, said system comprising a floating platform, wherein the mooring component is connected between the platform and a mooring line attached to a seabed.

25. A method of manufacturing a mooring component for a mooring system, comprising the steps of:
identifying a body to be moored and a location in which it is to be moored;
determining the expected environmental loading for the location;
determining the desired stress-strain response of the component to the expected environment loading; and
providing a plurality of different deformable elements having a reversible non-linear stress-strain response, wherein each element comprises an elastomeric material, and wherein the response is a composite reversible non-linear stress-strain response which is a combination of the responses of each of the plurality of elements and which matches the desired stress-strain response; or
providing a deformable element having a plurality of portions and a composite reversible non-linear stress-strain response that is a combination of the responses of each of the plurality of portions and which matches the desired stress-strain response.

26. (canceled)
